(19) United States
(12) Patent Application Publication
(10) Pub. No.: US 2025/0253375 A1
(43) Pub. Date: Aug. 7, 2025

(54) METHOD FOR OPERATING A REDOX FLOW BATTERY SYSTEM

(71) Applicant: Liva Power Management Systems GmbH, Frankfurt am Main (DE)

(72) Inventors: Thomas Lüth, Freiburg (DE); Christian Hättich, Freiburg (DE); Yifeng Li, Steinheim (DE)

(21) Appl. No.: 18/856,039

(22) PCT Filed: Feb. 22, 2023
(86) PCT No.: PCT/EP2023/054418

§ 371 Date: Oct. 10, 2024

(30) Foreign Application Priority Data
Apr. 13, 2022 (DE) 10 2022 109 002.7

(51) Int. Cl. H01M 8/18; H01M 8/04537; H01M 8/04858; H01M 8/04992

(52) U.S. Cl. CPC H01M 8/188; H01M 8/04634; H01M 8/04949; H01M 8/04992

(57) ABSTRACT

The present invention provides a method for operating a redox-flow battery system comprising at least two battery modules, wherein the redox-flow battery system comprises a measuring device for providing a measured variable representing a measure of the state of charge of each battery module, and wherein the method comprises the following steps: cyclic operation of the redox flow battery system; detecting measured values by use of the measuring device; carrying out at least two balancing interventions on a battery module during a half cycle; and wherein the last balancing intervention carried out in the half-cycle is of the overcompensating type, and an SoC₂ value used for this balancing intervention is predicted with the aid of pre-trained AI.

The invention relates to a method of operating a redox flow battery system, wherein the redox flow battery system comprises a plurality of battery modules connected in series, and wherein the method relates to reducing or eliminating imbalances between battery modules connected in series occurring during charging and discharging of the battery system.

Methods for reducing or eliminating imbalances between battery modules connected in series that occur during charging and discharging of the battery system are known from the prior art. For example, DE 10 2020 108053 A1 discloses such a method. Measures for reducing or eliminating said imbalances are usually referred to as ‘balancing’.

It is the object of the present invention to further optimize the methods known from the prior art.

According to the invention, the object is achieved by a method according to the independent claim. Further advantageous embodiments of the present invention can be found in the sub-claims.

In the following, the invention is explained with reference to figures. The figures show in detail:

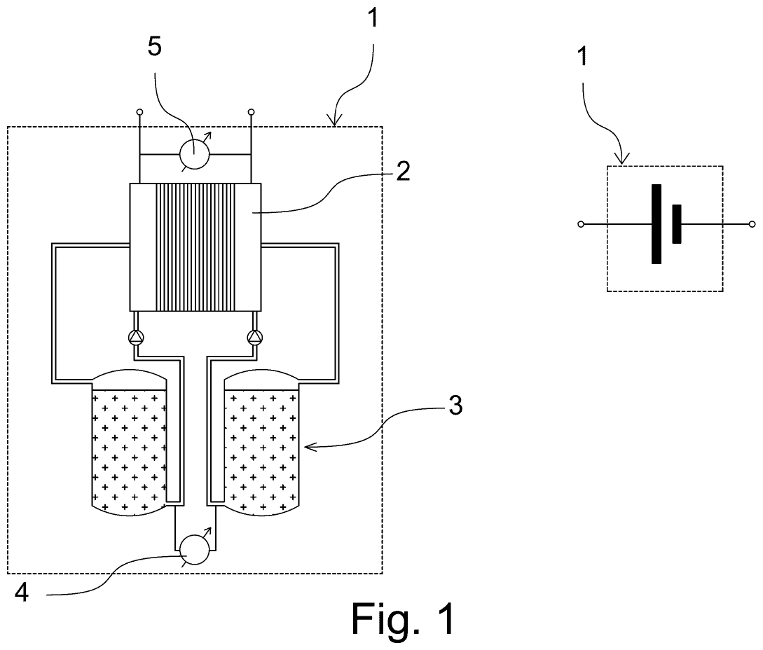

FIG. 1 Battery module;

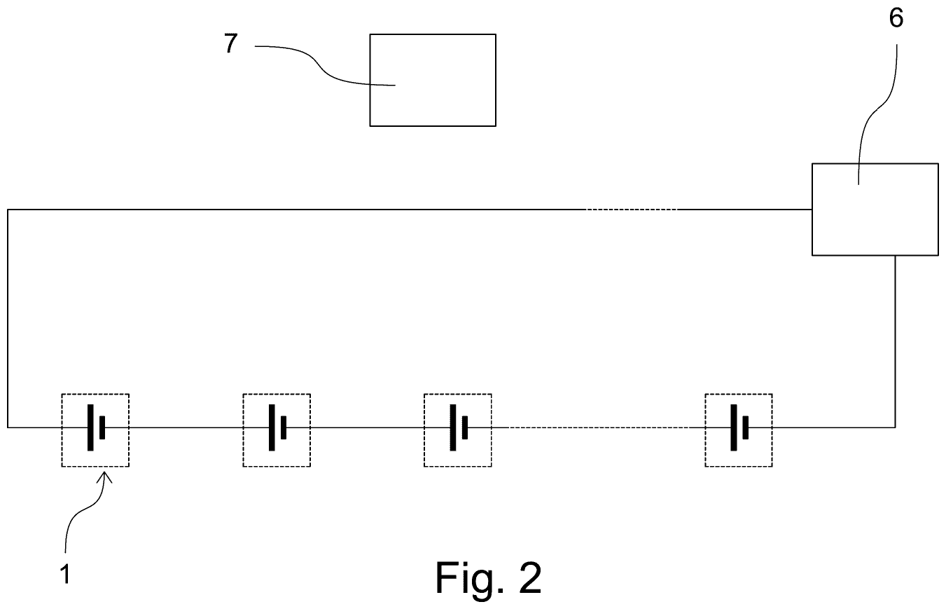

FIG. 2 Battery system;

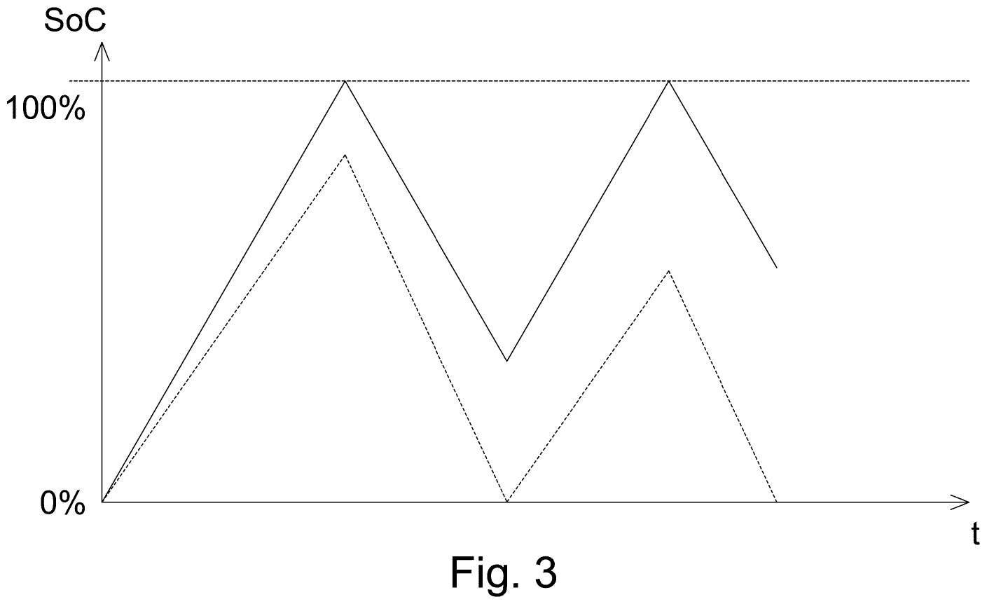

FIG. 3 Charge/discharge cycles without balancing;

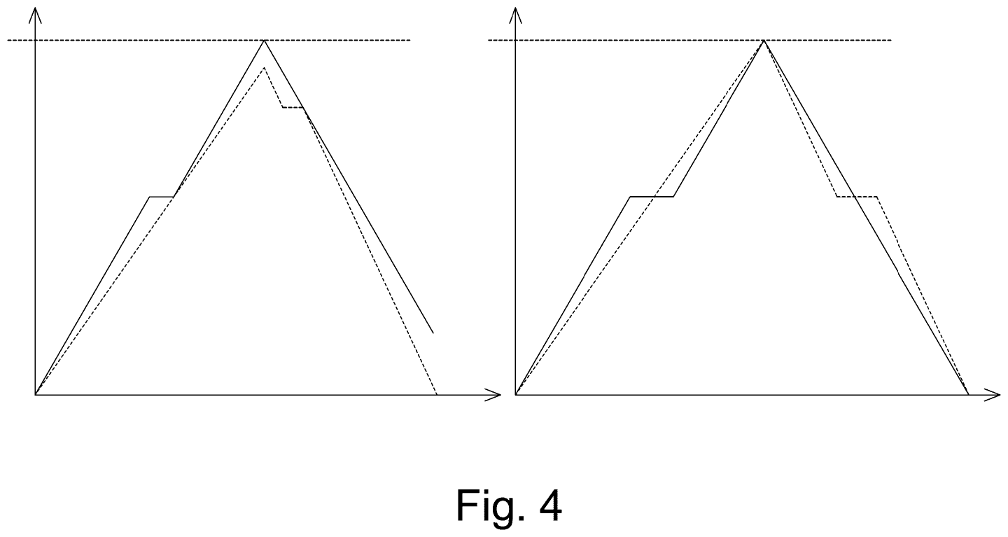

FIG. 4 Charge/discharge cycles with balancing by “decoupling”;

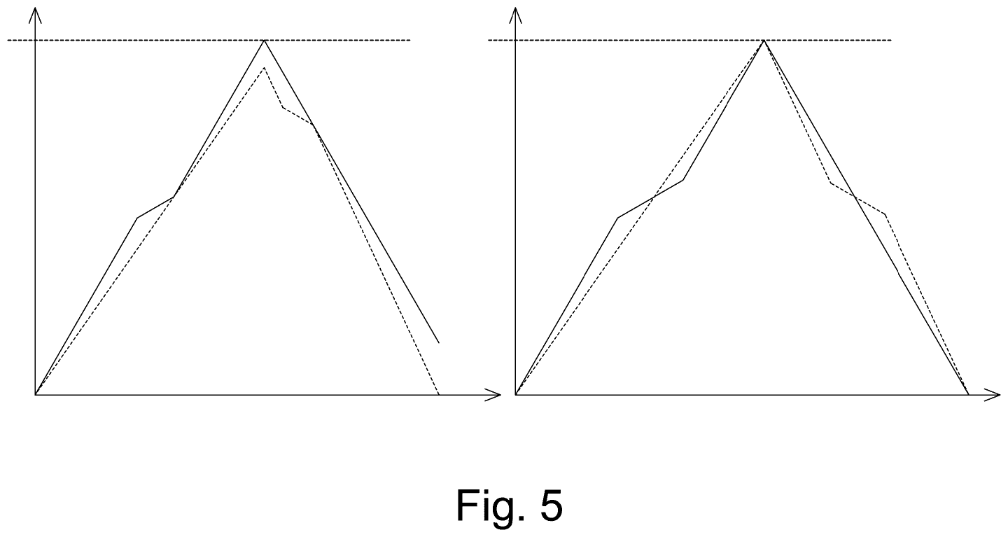

FIG. 5 Charge/discharge cycles with balancing by “misuse”; and

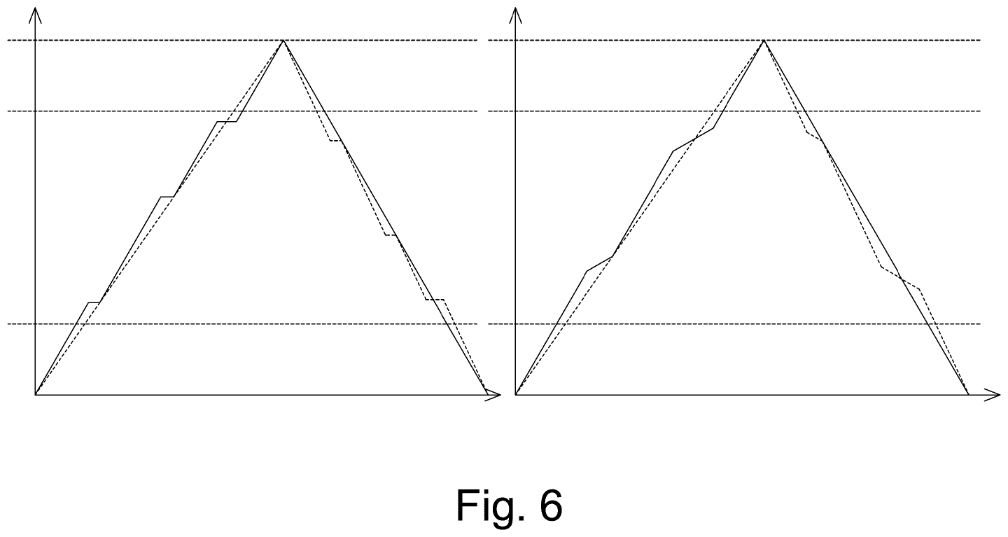

FIG. 6 Charge/discharge cycles with several balancing steps per half cycle according to the present invention;

FIG. 1 shows a schematic representation of a battery module on the left side. The battery module is designated with 1. The battery module comprises a cell arrangement, designated with 2, a tank device, designated with 3, and a measuring device for detecting a controlled variable.

The cell arrangement 2 is an arrangement of a large number of redox flow cells, which can be arranged as desired. For example, it could be a single cell stack, a series connection of several stacks, a parallel connection of several stacks, or a combination of series and parallel connection of several stacks. The tank device 3 is used to store the electrolyte and to supply the cell arrangement 2 with electrolyte. With a few exceptions, the tank device 3 comprises at least two tanks, a pipe system for connecting the tanks to the cell arrangement 2 and pumps for supplying the electrolyte. Here, FIG. 1 shows two separate pumps. The electrolyte could just as well be pumped with a double-head pump, i.e. with two pumps that are driven by a common motor. Here, the tank device 3 is designed in such a way that it can supply all cells of the cell arrangement 2 with electrolyte.

The battery module 1 shown in FIG. 1 comprises two measuring devices for providing a measured variable that represents a measure of the state of charge of the associated battery module (SoC—State of Charge). The measuring device, designated with 4, is a measuring device for providing the so-called open circuit voltage (OCV). The OCV value is a measure of the state of charge of the battery module (SoC). The measuring device, designated with 5, is a measuring device for providing the terminal voltage of the cell arrangement 2 and thus also of the battery module 1. When charging or discharging the battery module 1, the terminal voltage differs from the open circuit voltage by the voltage that drops across the internal resistance of the cell arrangement 3. If the charging or discharging current and the internal resistance of the cell arrangement 2 are known, the terminal voltage represents a measure of the state of charge of the battery module. An alternative to determining the OCV value is the so-called coulomb counting, which is also a measure of the state of charge of the battery module. This requires a measuring device to provide the current flowing through the modules connected in series. Such a measuring device for coulomb counting could therefore also be implemented outside the battery modules 1, so that a battery module 1 therefore optionally comprises a measuring device for providing a controlled variable. In any case, a battery system according to the invention comprises at least one measuring device for providing a measured variable which represents a measure of the state of charge for each battery module 1 of the battery system.

A symbolic representation of the battery module 1 is shown on the right side of FIG. 1. The symbolic representation is used in the following.

FIG. 2 shows a schematic representation of a battery system. The battery system comprises at least two battery modules, one of which is designated with 1, a bidirectional power conversion system (PCS), designated with 6, and a control device, designated with 7. The battery modules 1 are connected in series and connected to the conversion system 6. FIG. 2 shows four battery modules, wherein the dotted lines in the series connection are intended to indicate any number of additional modules. The conversion system 6 connects the battery system to the mains or to a higher-level electrical system. The series connection of battery modules shown is also referred to as a battery string.

In a battery system as shown in FIG. 2 with completely identical battery modules 1, no harmful imbalance could occur. However, real battery modules 1 differ from each other due to manufacturing variations and ageing processes. In addition, different operating conditions, e.g. temperature differences, between the individual modules, can cause them to behave differently (since the internal resistance of the modules depends, among others, on the temperature of the module—see below). For these reasons, real battery modules have different efficiency values and different internal resistances. For a given charging or discharging current, a higher efficiency results in that the final state of the battery module in question is reached more quickly. Because the same current flows through all battery modules 1 in the series connection shown in FIG. 2, the modules with high efficiency reach the end state faster than the modules with low efficiency. In order to avoid damages, the charging or discharging process must be interrupted as soon as a module reaches the respective end state. In this way, without compensating for this effect, the usable storage capacity of such a battery system is reduced with each cycle passed (“capacity fading”). The different internal resistance of the modules has a similar effect. There are upper and lower limit values for the terminal voltage, which must not be exceeded or undercut. Even with identical efficiency, a module with a higher internal resistance reaches the respective limit value of the terminal voltage more quickly during charging or discharging than a module with a lower internal resistance. If the first module reaches a limit value, the respective process must be aborted, which also leads to a reduction in the usable capacity of the battery system. Alternatively, the power of the system could be reduced. In either case, these effects lead to an impairment of the system. Balancing is intended to reduce or completely eliminate the effects described in order to keep the usable capacity of the battery system permanently at a high level or to eliminate the impairment described. On the other hand, successful balancing enables the use of cells with a comparatively high spread in terms of efficiency and/or internal resistance, which of course is reflected in reduced production costs.

The control device 7 is designed to carry out the interventions required for balancing, which are described in detail further below. The control device 7 can be a separate unit or part of a higher-level control system, which provides further control functions of the battery system in addition to balancing.

In the following, the method according to the invention is explained for the case that the battery modules have different efficiency values, i.e. that the modules of a battery string reach the minimum or maximum state of charge (SoC) at different speeds. In the diagrams shown, the minimum state of charge is marked with 0% and the maximum state of charge with 100%. In addition, for the sake of simplicity, the charge/discharge cycles shown are shown for the case that charging and discharging are carried out with the same constant power.

It should be mentioned that the 0% and 100% values of the state of charge each refer to the usable range of the individual battery modules, wherein it is assumed for the sake of simplicity that the usable capacity of the battery modules connected in series is the same.

The method according to the invention relates to the cyclic operation of a battery system, wherein the term “cyclic operation” is defined very broadly. This is understood to mean an operation in which discharge phases alternate with charge phases. Here, the two phases mentioned each form a half-cycle. In each half-cycle, there can be any number of time periods of any length during which the battery system is in standby state. A standby state is understood to be the state in which the current through the battery string is zero. A half cycle therefore begins with a reversal of the current direction through the battery string and ends with the subsequent reversal of the current direction. A half cycle does not necessarily have to extend over the entire state of charge range (i.e. from 0% to 100%), but can start at any first state of charge value SoC₁ and end at any other state of charge value SoC₂. It is clear that for a charging half-cycle SoC₁<SoC₂, and for a discharging half-cycle SoC₁>SoC₂. The fact that the half-cycles shown in the figures of the application usually extend over the entire charge state range is only for the sake of clarity and is not to be understood as limiting.

FIG. 3 shows two charge/discharge cycles of two battery modules connected in series with different efficiency values. The difference in efficiency is chosen to be very high for clarity. In real battery systems, the efficiency differences are much smaller. In FIG. 3, the SoC curve of the battery module with the higher efficiency is shown as a solid line, and the SoC curve of the battery module with the lower efficiency is shown as a dashed line.

The more efficient battery module reaches the 100% SoC value when the less efficient battery module is not yet fully charged. Because the same current flows through both battery modules, the current must now nevertheless be reversed and the charging half-cycle ended, so that discharging already begins when the less efficient battery module is not yet fully charged. Due to this unequal starting point for discharging and the lower efficiency, the less efficient battery module reaches the 0% SoC value when the more efficient battery module is not yet fully discharged. Because the effects described act cumulative, the SoC curves of the two battery modules diverge further and further as the number of cycles increases and the usable capacity of the battery system continues to decrease.

The negative effect described can be avoided by taking balancing measures. The various types of possible balancing interventions are described in more detail below.

FIG. 4 shows two diagrams, each with a charge cycle of two battery modules connected in series with different efficiencies. In each case, a respective balancing intervention is carried out a respective half cycle. The balancing interventions are of the “decoupling” type. With this type of balancing intervention, one or more battery modules are decoupled from the series connection for a certain period of time so that they no longer participate in the charging or discharging of the other battery modules during this time. Ideally, the SoC curve for the decoupled modules is horizontal (self-discharge can be neglected).

The more efficient battery module is decoupled during the charging half-cycle and the less efficient battery module is decoupled during the discharging half-cycle. The difference between the two diagrams lies in the different decoupling times.

In the left diagram, the battery module in question is only decoupled until the two curves equalize each other. For example, when charging, the efficient battery module is decoupled until the less efficient battery module reaches the same state of charge that the more efficient battery module actually exhibits. The associated balancing interventions can be classified as being of the “equalization” type.

In the right diagram the battery module in question is decoupled for longer so that the two curves of the battery modules intersect. For example, in the charging half-cycle, the more efficient battery module is decoupled until the less efficient battery module has reached a sufficiently high “advance” during charging so that the more efficient battery module catches up the less efficient battery module just at the 100% SoC value. The associated balancing interventions can be classified as “overcompensating”.

It should be noted that the measure of overcompensation of course depends on the SoC₂ value at which the relevant half-cycle ends. As mentioned above, SoC₂ does not have to be 0% or 100%, but can be any of the values in between. For example, if the charging half-cycle were to end already at SoC₂=80% the more efficient battery module would have to be decoupled for a shorter time than in the example shown in FIG. 4.

If balancing interventions of the “decoupling” type are to be used, it is advantageous if the battery string is designed in such a way that maximally one battery module can be decoupled at a time at full charging or discharging power. If less charging or discharging power is demanded, several battery modules can be decoupled at the same time. This reduces the time required for balancing.

To carry out balancing interventions of the “equalization” type, it is sufficient for the battery management system controlling the interventions to be provided with the SoC values of the battery modules. For balancing interventions of the “overcompensate” type, the battery management system must perform a type of extrapolation. To do this, the battery management system also requires the slope of the SoC curves of the battery modules in question. These slopes can be determined in a known manner from the SoC measured values for different points in time. The known smoothing filters can be applied to the slope values determined in this way in order to minimize the influence of measurement errors. So-called moving average filters or such a filter extended with 2nd order exponential smoothing have proven to be effective.

FIG. 5 shows another type of balancing interventions. Here, the battery modules in question are not decoupled from the series connection, but a load is connected in parallel to the battery module in question. This results in the current flowing through the battery string branching in such a way that only part of the charging or discharging current flows through a battery module affected by such a balancing intervention. As a result, it is charged or discharged less quickly than without this intervention. This means that the corresponding SoC curve is less steep during the intervention than before or after the intervention. FIG. 5 again shows two diagrams, wherein the left diagram shows interventions of the “equalizing” type and the right diagram shows interventions of the “overcompensating” type. Balancing interventions, which are achieved by connecting a load in parallel, could also be casually referred to as of the type “misuse”, because part of the charging or discharging current is used for another purpose. It is advantageous if the loads connected in parallel are elements that are part of the battery system and need to be supplied with energy anyway. For example, the pumps of a battery module affected by such an intervention can be supplied with energy during the intervention by the diverted charging or discharging current, while they would otherwise be supplied by another energy source.

It should be noted that an “overcompensation” type intervention must be initiated in good time before the end of the corresponding half cycle is reached. This applies in particular to an intervention of the “misuse” type, because the battery module affected by the intervention also has a non-zero SoC slope in the case of “misuse”. In principle, such an intervention of the “decoupling” type can be carried out shortly before the SoC₂ value is reached, wherein the intervention then increasingly resembles an intervention of the “equalization” type the shorter the time interval before reaching the SoC₂ value is.

In the diagrams in FIGS. 4 and 5, one balancing intervention is respectively shown in each half cycle. However, more than one intervention per half cycle can be carried out if required. Such interventions are usually triggered by the battery management system if there are deviations between the SoC values of the battery modules that exceed a predefined threshold value. For example, the minimum and maximum values of the measured SoC values can be considered. Just as well the variance of these values could be formed and used to trigger balancing interventions. The smaller the threshold value is selected, the closer the SoC curves of the battery modules are kept together by the increasingly carried out balancing interventions.

It should also be mentioned that SoC curves, as shown in FIG. 5, can also be generated with the aid of “decoupling” type interventions. In this case, the interventions are triggered by the battery management system at a high frequency and with a correspondingly short duration. This means that the flattened curve shown in FIG. 5 during the intervention is approximated by a large number of small steps. Here, such a high-frequency sequence of decoupling and coupling steps is regarded as a single balancing intervention and classified with a type corresponding to the respective SoC curve (i.e. “equalization” or “overcompensating”).

It is also conceivable that the balancing interventions are only ever carried out during charging or only during discharging.

The inventors have recognized that the balancing methods known from the prior art can be improved by carrying out at least two balancing interventions during a half cycle, wherein the last balancing intervention carried out in the half cycle is of the “overcompensating” type. This allows the SoC curves of the battery modules to coincide at the end of the half-cycle. However, the inventors have also recognized that a balancing intervention of the “overcompensating” type can only be carried out in such a way that it leads to the desired result mentioned if the battery management system controlling the intervention “predicts” the SoC₂ value at which the current half cycle will end. The inventors have recognized that a reliable prediction of said SoC₂ value can be made by a pre-trained AI (artificial intelligence).

The training of the AI can be done in different ways. One option is that the training takes place on the same battery system on which the method according to the invention is to be carried out at a later point in time. For example, during the training phase, only balancing interventions of the “equalization” type can be carried out. Or if balancing interventions of the “overcompensate” type are carried out, then the prediction of the required SoC₂ value is carried out in a different way, i.e. not with the aid of the AI. For example, the SoC₂ value of the penultimate half-cycle can simply be used, or an average of several past half-cycles of the same type (i.e. either discharging or charging).

Another option for training the AI is to use historical data from another battery system used as similarly as possible for the training. Another option for training is to use artificially generated data. Certain known characteristics of the battery system on which the AI is to be used can be used for the artificial generation.

The AI can continued to be trained while it is being used for the method according to the invention, i.e. the AI can constantly “learn” during the course of the method according to the invention. It is therefore not necessary to train the AI perfectly in advance, but it is sufficient to carry out the training to such an extent that the prediction quality of the AI is at least as good as the above-mentioned simple prediction options (use of the penultimate half-cycle or calculation of an average value from several past half-cycles of the same type).

In order to predict the required SoC₂ value, the AI advantageously uses not only correlation variables from the battery system in question, but also correlation variables that are provided by the environment, such as weather data and weather forecast data from the area over which the electrical grid to which the battery system is connected extends. This is particularly advantageous when the battery system is used to regulate the grid.

The inventors have further recognized that it is advantageous if balancing interventions of the “decoupling” type are only carried out when the SoC values of the battery modules are in a range of 20% to 80%, i.e. are carried out in an SoC range in which the charging or discharging current is moderate. The switching operations required for the interventions can thus take place with less wear.

FIG. 6 shows two diagrams of the SoC curve of two battery modules in which balancing interventions are carried out according to the method of the invention. Here, in the left diagram, interventions of the “decoupling” type are used. In the right diagram, the interventions shown can be of the “misuse” type or can be caused by high-frequency “decoupling” (see above). In both diagrams, the 20%-80% SoC range is marked by two additional horizontal dashed lines. All balancing interventions take place in the SoC range between these lines, i.e. the intervention respectively ends in this range (important for the interventions in the right diagram, where the SoC value of the battery module in question changes during the intervention). It should be noted that in the right diagram this criterion is only advantageous if the curve shown is caused by high-frequency decoupling. In the left diagram, three interventions take place per half-cycle, whereas in the right diagram only two interventions take place per half-cycle. Here, the last intervention per half cycle is respectively of the “overcompensate” type, while the other interventions are of the “equalization” type. Here, the SoC₂ value completing each half cycle is respectively 0% or 100%. As already mentioned above, however, any other SoC₂ values can complete the half cycles.

It should be noted that the “decoupling” and “misuse” types can also occur in a mixed form during a half-cycle.

Finally, it should be noted that the battery management system controlling the interventions is a computer program that runs in the control device 7. This means that the control device 7 controls the balancing interventions and detects the SoC measured values of the individual battery modules 1 for this purpose. However, other measured variables (see above) can be used as control variables, e.g. also the measured values of the terminal voltages of the battery modules 1, since these scale with the SoC values of the same. Here, the AI used to predict the SoC₂ value is part of the computer program.

### LIST OF REFERENCE SYMBOLS

1 Battery module
2 Cell arrangement
3 Tank device
4 Measuring device for determining the OCV
5 Measuring device for determining the terminal voltage
6 Bidirectional conversion system (PCS)
7 Control device

1. A method of operating a redox flow battery system comprising at least two battery modules, a bidirectional conversion system, and a control device,
wherein the at least two battery modules are connected in series and connected to the bidirectional conversion system,
wherein each of the at least two battery module comprises a cell arrangement with a plurality of redox flow cells and a tank device for storing electrolyte and for supplying the cell arrangement with the electrolyte,
wherein the redox flow battery system comprises a measuring device for providing a measured variable which represents a measure of a state of charge (SoC) of each of the at least two battery module,
wherein the method comprises:
cyclically operating of the redox flow battery system;
detecting measured values using the measuring device; and
carrying out at least two balancing interventions on a battery module of the at least two battery modules during a half cycle, and
wherein a last balancing intervention of the at least two balancing interventions carried out in the half cycle is of an overcompensating type, and an SoC₂ value used for the last balancing intervention is predicted using a pre-trained AI.

2. The method according to claim 1, wherein at least one of the at least two balancing interventions carried out is of a decoupling type and the at least two balancing interventions are only carried out when the battery module is in a state of charge between 20% and 80%.

3. The method according to claim 1, wherein at least one of the at least two balancing interventions carried out is of a misuse type.

4. The redox flow battery system configured to carry out the method according to claim 1.

5. A computer program configured to carry out the steps of the method according to claim 1.

6. A data carrier on which the computer program according to claim 5 is stored.

7. The method according to claim 2, wherein at least one of the at least two balancing interventions carried out is of a misuse type.

8. The redox flow battery system configured to carry out the method according to claim 2.

9. The redox flow battery system configured to carry out the method according to claim 3.

10. A computer program configured to carry out the steps of the method according to claim 2.

11. A computer program configured to carry out the steps of the method according to claim 3.
